(19) United States
(12) Patent Application Publication
(10) Pub. No.: US 2002/0055350 A1
(43) Pub. Date: May 9, 2002

(54) Apparatus and method of toggling between text messages and voice messages with a wireless communication device

(76) Inventors: Ash Gupte, Hillsboro, OR (US); Ronald Olshausen, Portland, OR (US)

Correspondence Address: PERKINS COIE LLP, PATENT-SEA, P.O. BOX 1247, SEATTLE, WA, 98111-1247, US

(21) Appl. No.: 09/910,446

(22) Filed: Jul. 20, 2001

Related U.S. Application Data
(60) Provisional application No. 60/219,592, filed on Jul. 20, 2000.

(51) Int. Cl. H04Q 7/20

(52) U.S. Cl. 455/412; 455/413; 455/466; 455/566

(57) ABSTRACT

Under one aspect of the invention, a mobile communication management system is provided for electronic communications to and from a wireless communication device in text and speech formats. The system of one embodiment includes a server system with an electronic data storage portion. A message notification portion provides notification to a wireless communication device associated with the user that the electronic communication data was received by the data storage portion. A message delivery portion sends and receives the message delivery instructions and electronic communications over a data channel portion and a voice channel portion of the wireless communication device during a single communication session. The message delivery portion allows the user to toggle between the data and voice channel portions for the exchange of the data in text and voice formats as selected by the user during the single active communication session.

### CROSS-REFERENCE TO RELATED APPLICATION

This is a non-provisional patent application claiming priority from U.S. provisional Patent Application Serial No. 601219,592, filed Jul. 20, 2000, and which is hereby incorporated by reference thereto.

### TECHNICAL FIELD

This invention relates to a message management system, and more particularly to a mobile communication management system to receive and deliver messages in text and voice formats over wireless communication devices.

### BACKGROUND OF THE INVENTION

A large number of communication systems have been developed and are used extensively by people to send and receive information. These systems include conventional landline telephone systems, wireless communication systems, voicemail systems, and electronic messaging (i.e., email) systems. These systems, particularly the wireless communication systems and email systems, have allowed people to greatly increase mobility while still being able to access the communication systems to receive or send information.

The wireless communication devices, such as cell phones, allow a person to access voicemail systems and text-based networks, such as the Internet. The wireless communication devices can also allow the user to send or receive emails in text format. Laptops, notebook computers, Personal Digital Assistants (PDAs), two-way text pagers, and other wireless hand-helds also allow a person to access the Internet, send text emails, or receive text emails. Accordingly, business travelers can stay in touch with their offices and homes via email and voicemail through cell phones, computers, PDAs, two-way text pagers, and other wireless communication devices.

While the conventional communication systems can be extremely powerful tools, they still have some drawbacks and limitations. Laptops and notebook computers can be heavy and awkward to carry, and they can be cumbersome to use to access email, particularly when traveling. The wireless communication devices, such as cell phones, two-way text pagers, and PDAs, are easier to carry and can send or receive emails in text format. Most wireless communication devices, however, have small display screens that limit the amount of information that can be seen so reading text messages can be cumbersome.

Many cell phones and other wireless communication devices are configured for data transmission over a voice channel, a data channel, or a narrower band SMS channel. Some cell phones that use a Short Message Sending (SMS) protocol can only receive or send short messages over the SMS channel with a limited number of characters (e.g., up to 160 or 250) per message. Other cell phones are equipped with a browser that allows the phone to send or receive longer communications over the data channel, which has a broader band than the SMS channel. The cell phones can also send and receive data in speech format over the phone's voice channel.

The most recent generation of cell phones support a rapidly emerging communications protocol called WAP, or Wireless Application Protocol. WAP is the transport mechanism over the data channel for a text markup language called Wireless Markup Language (WML). WML is quite similar to Hyper Text Markup Language (HTML), in that it is a markup language derived from Standard Generalized Markup Language (SGML) for presenting text and images in a standardized format. Like HTML pages, WAP pages are served up by popular Internet servers. The current wireless Internet infrastructure, however, offers very limited bandwidth. Typically, the bandwidth used by WAP applications is only 14 kilobaud, or about one-fourth the capacity of a typical dial-up modem connection. As such, WAP applications are typically limited to small exchanges of text, with little or no associated graphics. Several popular web portals have created WAP versions of their sites. As WAP phones currently allow only black-and-white bitmap displays, WAP Internet sites offer little or no graphic content.

In all cases, these are text-only applications for transmission over the data channels between a server and a cell phone or other wireless communication device. The transmission of data in text format over the data channels does not interact with the Plain Old Telephone Service (POTS) infrastructure. Accordingly, present cell phones and other similar wireless communication devices can only transmit over the voice channel, the data channel, or the SMS channel separately. The cell phones cannot receive or send data simultaneously over the voice and data channels. Accordingly, the WAP applications that run on a cell phone and the telephone calls placed to or from the cell phone figuratively travel through two separate and distinct “pipes” that do not overlap. Therefore, if data is made available to the cell phone in text format and in voice format, the current cell phones must access the data separately in a cumbersome procedure to send or receive the data over the separate communication channels during separate communication sessions with servers from which the data is sent or received. Therefore, it is presently cumbersome for a user to use cell phones or other mobile communication devices running on conventional systems to retrieve and act on voicemail messages and on text-based messages.

### SUMMARY OF THE INVENTION

The present invention is directed to apparatus and methods that overcome drawbacks experienced in the prior art. Under one aspect of the invention, a mobile communication management system is provided for electronic communications to and from a wireless communication device in text and speech formats. The mobile communication management system of one embodiment includes a server system with an electronic data storage portion that receives electronic communication data for a specified user. The electronic data storage portion stores the electronic communication data to be accessible by the user. A message notification portion is configured to provide notification to a wireless communication device associated with the user that the electronic communication data was received by the data storage portion. A message delivery portion is configured to send and receive the message delivery instructions and electronic communications over a data channel portion and a voice channel portion of the wireless communication device during a single communication session between the server system and the wireless communication device. The message delivery portion is configured to allow the user to toggle between the data and voice channel portions for the exchange of the data to the wireless communication device in text and voice formats as selected by the user during the single active communication session between the server system and the wireless communication device.

Another aspect of the invention includes an information communication system for delivery and management of electronic communications in speech and non-speech formats via a wireless communication device. The system includes a wireless communication device having a data channel portion and a voice channel portion for receiving and delivering electronic communications thereover. A server system is configured to receive electronic communications for a specified user and stores the electronic communication in a selected location. The server system is also configured to communicate with the wireless communication device. The server system receives a communication from the wireless communication device and utilizes data from the wireless communication device and the server to map the communication to the selected electronic communication stored at the server for the user. The server system receives message delivery instructions from the wireless communication device. The server system also delivers electronic communication data to the wireless communication device over each of the data channel portion and the voice channel portion as selected by the user during the same communication session between the wireless communication device and the server system. The user can toggle between the data and voice channel portions for the transmission of the electronic communication to and from the wireless communication device during a single communication session with the server system.

Another aspect of the invention includes a method of toggling between electronic communication delivery over data and voice channel portions of a wireless communication device during a single, active communication session with a server system. The method includes receiving an electronic communication by a server system from a remote server and storing the electronic communication in the server system in a unique storage location for that electronic communication. An electronic communication is provided to the wireless communication device over the data or voice channel portions of the wireless communication device indicating the presence of the electronic communication at the server system. An active communication session is established between the server system and the wireless communication device for acting on the electronic communication in the server system.

The server system and the wireless communication device allow the user to toggle between the data and voice channel portions during the same active communication session to provide instruction communications to the server system for acting on the electronic communication. In one embodiment, the method also includes maintaining communication session information about the actions taken by the server system f or the electronic communication. In another embodiment, the method includes terminating the active communication session if the time between communications to the server system from the mobile communication exceeds a selected time period.

### BRIEF DESCRIPTION OF THE DRAWINGS

FIG. 1 is a schematic representation of the mobile communication management system of one embodiment of the present invention.

FIG. 2 is a schematic representation of a WAP data communication loop in a communication session portion in the system of FIG. 1.

FIG. 3 is a schematic representation of a voice communication loop in a communication session portion in the system of FIG. 1.

FIG. 4 is a schematic representation of a voice portion of a communication session of FIG. 1 illustrating voice-based options for electronic communications over th e voice channel portion.

FIG. 5 is a schematic representation of a communication session with the system above FIG. 1 showing the toggling from the voice channel portion back to the data channel portion during the same communication session.

FIG. 6 is a schematic flow diagram showing a communication flow in an embodiment that transmits electronic communication in a WAP scheme and a POTS scheme as selected by a user by toggling between data and voice channel portions of wireless communication device.

### DETAILED DESCRIPTION

A mobile communication management system and related methods that allow for toggling between voice and data channel portions of a wireless communication device during a communication session in accordance with embodiments of the present invention are described in detail herein. The system and methods are configured to transmit selected electronic communication messages between a wireless communication device and a server system in a text format and a voice format during a communication session as selected by a user. The user can toggle between the voice and data channel portions during the same communication session with the server system to send or receive the electronic communications in the voice and text formats as desired without ending the active communication session. The user can toggle between the voice and data channel portions for transmissions of the electronic communication upon performing select actions on the wireless communication device, such as depressing one or more selected keys on a cell phone.

The following description provides specific details for a thorough understanding of, and an enabling description for, embodiments of the invention. However, one skilled in the art will understand after reading the following description that the invention may be practiced without some these details. In other instances, well-known structures and functions have not been shown or described in detail to avoid unnecessarily obscuring the description of the embodiments of the invention.

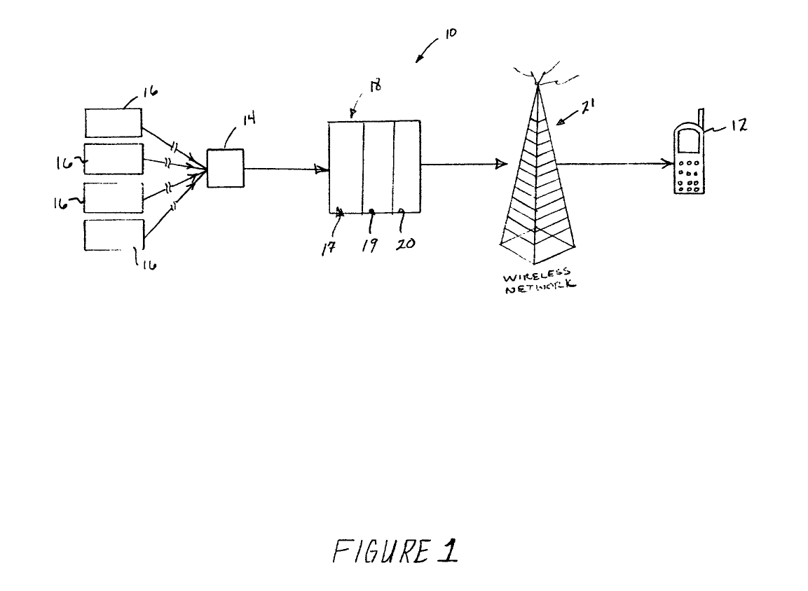

FIG. 1 is a schematic representation of the mobile communication management system 10 of one embodiment of the present invention. The system 10 allows a user to directly access one or more selected messages and act on the message in either a voice or text format as selected by the user via a cell phone 12 or other selected wireless communication device. This embodiment will be described with reference to accessing and acting on email communications via a cell phone, although it is to be understood that the system and methods are applicable to other electronic communication messages and wireless communication devices, not just emails and cell phones.

The mobile communication management system 10 is operatively connected to a user's email server 14, which is configured to receive a plurality of emails 16 sent to the user via his or her unique email address. Components of the message management system 10 are similar to a message management system described in co-pending the U.S. patent application Ser. No. 09/782,686, filed Feb. 12, 2001, which is hereby incorporated herein in its entirety by reference thereto.

The emails 16 may include text and attachments, such as data files or audio files. The user's email server 14 is a remotely located server that sends the emails in a conventional manner to an email server 17 on a server system 18 in the system 10. The email server 17 acts as a relational database that can be configured with selected criteria rules to determine if an email 16 satisfies the selected criteria rules for handling the email. The server system 18 in one embodiment also includes a WAP application server 19 and a telephony server 20 that perform a variety of actions, as discussed in greater detail below. In another embodiment, the server system 18 may include additional servers, or may be only one or two servers that perform all of the necessary actions.

The server system 18 in one embodiment is configured so that, if an email is received that meets the selected criteria as determined by the relational database in the email server 17, the server system sends a notification in text format over a conventional wireless network 21 to the user's cell phone 12. The notification indicates that a specific email has been received from the user's email server 14. The notification from the server system 18 is provided to the cell phone 12 in a selected interactive protocol scheme, such as a Wireless Access Protocol (WAP) scheme, that can be recognized by the cell phone.

The user can respond to the notification by activating the cell phone 12 (e.g., depressing a selected key 22 on the phone's key pad 24) connecting with the server system 18 in either a text format or voice format, thereby initiating an active communication session with the server system. In another embodiment, the user can initiate the active communication session between the cell phone 12 and the server system 18 independent of receiving a notification. The user sends a text-based or voice-based communication to the server system 18 from the cell phone and logs into the server system to achieve authentication for accessing the user's account containing one or more selected emails or other communications residing on the server system 18 for that user.

The server system 18 is configured to communicate with the cell phone 12 during the active communication session over both the voice and data channel portions as selected by the user in order to act on the selected email. The user can toggle between the voice and data channel portions while in the same active communication session to selectively act on the email in either a text format (e.g., to read, reply or compose a text email) or in voice format (e.g., to listen, reply, or compose a speech-based email). This provides significant versatility for the user to act on his or her email messages from the cell phone during only one wireless communication session with the server system.

At least a portion of the notice in the WAP protocol scheme of the illustrated embodiment has embedded information that allows the cell phone 12 to automatically access the server system 18 with only a single action by the user, such as by pressing one key 22 on the phone's keypad 24. This single action by the user will provide only that user with access to the email message in his or her account, so the user can receive or act on that message without having to perform a separate log-in arid authentication process. Accordingly, the user can skip the log-in step and quickly and easily act on the one selected email for which the notice was sent without having to sort through a large number of other emails.

In the present embodiment, the server system 18 is configured to use a combination of identifiers about the email, the cell phone, the user's account, and the transmission to the server system to map the transmission to a selected email for the user. As an example, the server system 18 receives the email communication from the user's server 14 and stores the email 16 in a unique location associated with information regarding the user's account. The storage location is also associated with the identification information of the cell phone 12 associated with the user's account. The server system 18 also establishes a unique message identification (ID) for each email.

When the server system 18 provides the notification to the cell phone 12, the notification is in a WAP scheme that contains a unique notification event identifier embedded in a URL (Uniform Resource Locator) string. When the cell phone references the specific URL using the specified event identifier, the server system matches the event identifier and the handset's WAP subscriber ID to a specific message and an associated action (e.g. view the message, reply to it, or forward the message). When the cell phone 12 connects with the server system 18 over the data channel portion for the selected email, the communication from the cell phone also includes specific cell phone ID and a handset WAP ID string that the server system 18 uses to map and identify the particular active communication session from the email established between the cell phone and the server system. The server system 18 also maps the WAP ID string and the caller ID to the message ID to quickly retrieve the specific email for which the user was accessing the system. The user can then act on the specific email in voice and text format as selected by the user by toggling between voice-based and text-based communications during the same communication session.

After the server system 18 retrieves the selected email, the server system sends a WAP menu to the cell phone 12 over the phone's data channel portion. The WAP menu has several voice-based and text-based options for acting on the selected email. The user can select from the menu for acting on the email, such as reading, listening, replying, replying to all, saving, deleting, or composing a new email. These menu items include options that utilize communications in the text format (e.g., read, reply by text), and the voice format (e.g., listen, reply by voice). Each menu item also has a unique embedded code for the particular menu item that is recognized by the server system for that item. Accordingly, the server system 18 can act accordingly for a response for each menu item provided for the selected email.

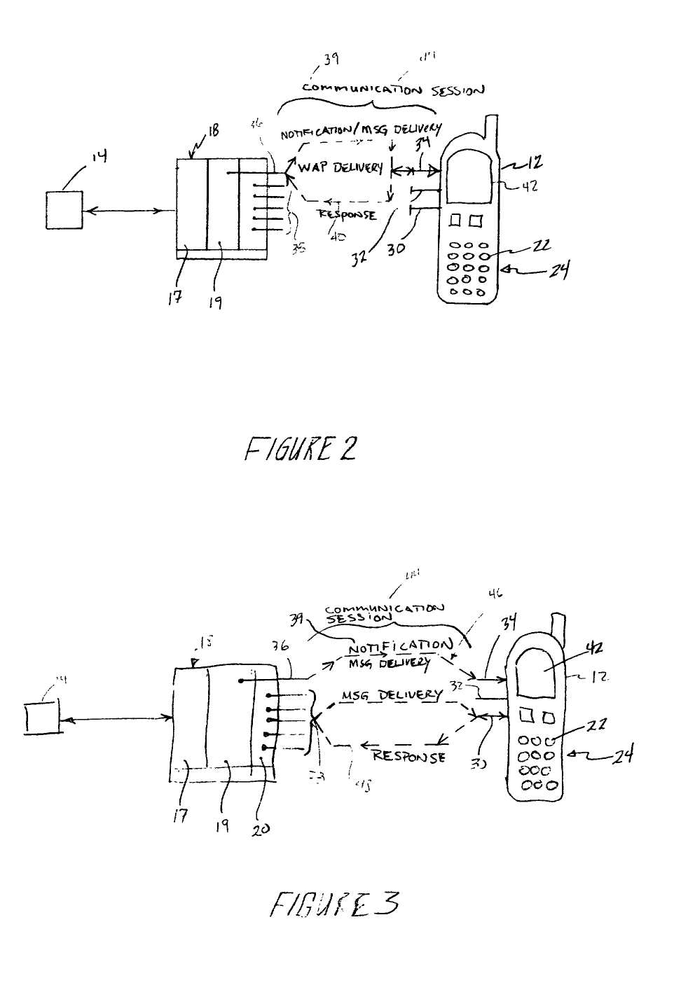

FIG. 2 is a schematic representation of a WAP data communication loop in a communication session portion in the system of FIG. 1. The cell phone 12 of the illustrated embodiment has three different communication channels, along which different types of information or data can be transmitted. The first channel is a voice channel 30, the second channel is an SMS channel 32, and the third channel is a data channel 34. These three channels 30, 32, or 34 are used to provide the closed data communication loops 28 for transfer of information or data between the server system 18 and the cell phone 12. The server system 18 is also configured to receive information or data along data lines 36 and conventional voice-based phone lines 38.

In the embodiment illustrated in FIG. 2, the server system 18 receives an email 16 from the email server 14, and stores the email in a unique location. The server system 18 provides a WAP notification 39 to the cell phone 12 over the data channel 34. The WAP notification 39 can include, as an example, text that indicates the presence of the email received by the server system 18 for the user. The WAP notification can also include the menu of options for acting on the email. In one embodiment, the menu can include the options of reading, replying, replying to all, forwarding, saving, or deleting the email message. The menu can also include the option to compose a new email message, as well as other options. The WAP notification is viewed on the cell phone 12 via the WAP browser or another data browser in the cell phone. The user can then select a menu item for acting on the email message in either text format or voice format.

When the user responds to the notification and selects a specific message for viewing in data format, the cell phone 12 sends a WAP response 40 to the server system 18 over the data channel 34. The sending of the WAP response 40 initiates the active communication session 44 between the cell phone 12 and the server system 18. The server system 18 maps the WAP ID string and the cell phone ID to the specific email for which the notification was sent. The server system downloads a WAP page in Wireless Markup Language (WML) to the cell phone 12 over the phone's data channel 34. The WAP page contains the email text. The email text is displayed on the cell phone's screen 42. The user can then scroll through and read the email message via the cell phone's WAP browser. The user can also act on the email message by using the menu options provided to the cell phone 12 to select the particular action for that email. When the user selects a menu item for acting on the email in text format, the communication exchange between the cell phone 12 and the server system 18 is provided over the date channel 34 in a text session portion (e.g., a WAP session) of the active communication session.

FIG. 3 is a schematic representation of a voice-based communication loop in a communication session portion in the system of FIG. 1. The server system 18 is also configured so the user can select a voice-based action from the menu of options, and the communication session switches from the text session portion to a voice session portion over the voice channel 30 without ending the active communication session 44. After the notification or other WML page is downloaded to the cell phone 12 over the data channel 31 from the WAP server 19, the user can elect to toggle to a voice portion of the active communication session 44 to, as an example, listen or reply to the email in voice format. When the user toggles to the voice session portion 48, the server system 18 suspends the text session portion 46 and the cell phone 12 switches to the voice channel 30 to communicate with the server system 18.

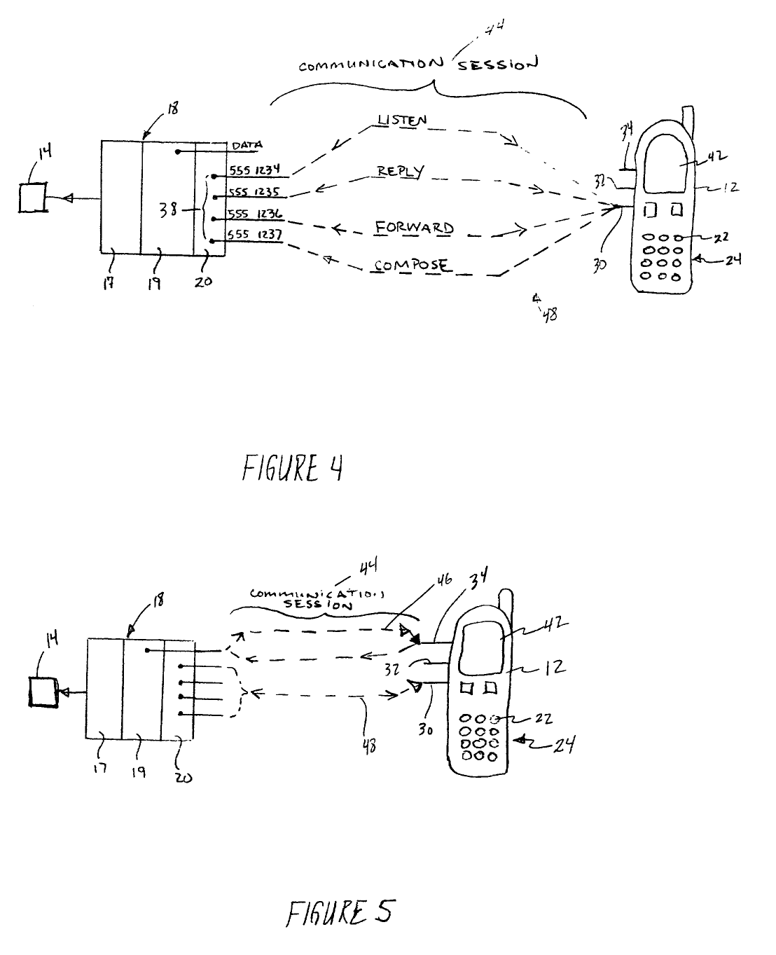

FIG. 4 is a schematic representation of a voice portion of a communication session of FIG. 1 illustrating voice-based options for the voice session portion 48 of a communication session 44 in one embodiment of the invention. When the user elects a voice-based action and toggles to the voice session portion 48, the cell phone 12 dials a selected phone number assigned to a phone line on voice channel 38 of the server system 18, thereby initiating a standard telephone call to the telephony server 20 in the server system. The telephony server 20 receives the phone call, and the server system 18 maps the phone lines' telephone number and the cell phone ID to the user's active communication session 44 and the server accesses the correct email. The user can then act on the retrieved email in the voice format during the voice session portion 48.

If, as an example, the user elects to listen to the email, the user selects the menu option for listening. The server system 18 accesses the email as discussed above, converts it from text to speech, and delivers the email to the cell phone 12 in voice format over the voice channel 30. If the user elects to respond to the email in voice format, the user selects the appropriate menu item, provides the oral response as prompted by the server system 18, and the server system records the user's response over the voice channel 30. The voice-based response is saved as a Wave File that can be attached to a response email, which is to be sent from the server system 18 to a selected recipient.

In the embodiment illustrated in FIG. 4, the server system 18 is also configured to provide the user with several menu options for responding to the email or other electronic communication during the voice session portion 48 of the active communication session. Each menu item for the voice-based actions includes an embedded telephone number unique to the selected action. Each telephone number is associated with a selected phone line 38 of the telephony server 20. When the user selects a voice-based menu option, the cell phone 12 invokes a WTAI call to the server system 18 over the voice channel 30. The telephony server 20 receives the phone call on one of the phone lines 38, and the server system 18 maps the call to a selected action for the email by utilizing the phone line's phone number, the phone ID, and message ID. The server system 18 then executes the voice interface on the specific message selected. While the illustrated embodiment uses the phone lines with separate telephone numbers assigned each menu option for the voice-based actions, other identification schemes can be used for each of the menu items for mapping to the selected response and the email in the particular user's account.

After the user completes the desired voice-based action, such as listening or replying to the email, the telephone line connection between the cell phone 12 and the telephony server 20 is terminated, thereby ending the voice session portion 48 of the communication session 44. The user can then toggle back to the text session portion 46 of the communication session 44 for additional text-based interface with the server system 18. Alternatively, the user can terminate the entire active communication session 14 if no further action is desired with the server system.

When the user toggles from the text session portion 46 to the voice session portion 48, the menu list remains in the cell phone's WAP browser while the voice session portion proceeds. Accordingly, the user toggles back to the text session portion 46 by accessing the menu on the cell phone 12 and selecting a text-based menu item. The cell phone 12 then sends a WAP communication to the WAP application server 19 of the server system 12, and the WAP communication and associated instructions is mapped to the email as discussed above. The server system 18 then acts on the email per the instructions.

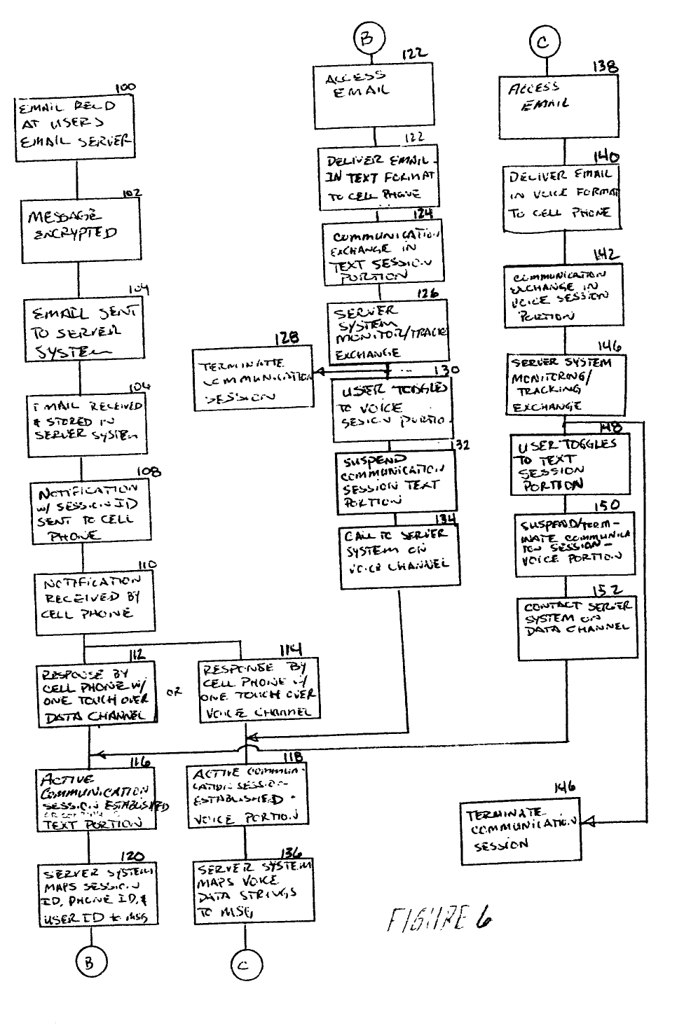

FIG. 5 is a schematic representation of a communication session 44 with the system above FIG. 1 showing the toggling from the voice channel portion 48 back to the text session portion 46 during the same active communication session 44. When the text-based menu item is selected, the cell phone 12 toggles from voice channel 30 back to the data channel 34 to resume the text session portion 46 by sending a WAP message to the server system 18. The WAP message has embedded identification strings that the server system 18 uses to map the WAP message to the email involved in the active communication session. The server system 18 then acts on the email per the WAP message. The user can then perform another voice-based action during the same active communication session 44 with the server system 18. This toggling action provides the user with substantial flexibility for handling and managing email or other electronic communications from a cell phone 12 or other mobile communication device.

In the illustrated embodiment, the server system 18 is provided with a time-out feature that increases the security of the email or other electronic communications residing on the server system. The server system 18 is configured to terminate the active communication session 44 if too much time elapses between the communications transmitted between the server system 18 and the cell phone 12. As an example, the server system 18 maintains session data on a continuous basis during the active communication session, including the time elapsed to and from the server system 18 via the cell phone 12. The communication session 44 remains active as long as a response is provided from the cell phone 12 to the server system 18 within a selected time period. This time period can be any selected increment to provide the desired level of security for the system. The time increment is shorter (e.g., minutes or seconds) for higher security systems, and longer (e.g., hours or days) for lower security systems. If the user does not provide a response to the server 18 via the cell phone 12 within the defined time period, communication session “times out” and the server system terminates the active communication session.

In the illustrated embodiment, the server system 18 is configured to maintain data session information for the actions on the email during the communication session. Accordingly, the server system 18 tracks whether the email has been read, responded too, deleted, forwarded, or the like, so the server system stays up-to-date regarding the status of each email. If the user later accesses the server system 18 for a selected message, the user will have to initiate a new communication session either by performing a log-in procedure with the server system or by responding to a notification from the server for that selected email, as discussed above. The server system 18 can utilize data session information for each email, so the user can begin the second communication session at the point where the first communication session terminated.

FIG. 6 is a schematic flow diagram showing a communication flow in an embodiment that transmits electronic communications in a WAP scheme and a POTS scheme. In the illustrated embodiment, an electronic communication, such as an email, is received at a user's email server (block 100). The email can then be encrypted (block 102). In the illustrated embodiment, the email is encrypted with SSL encryption, although other encryption methods or techniques can be used. In other embodiments, separate encryption of the email may not be desired or necessary such that the encryption process is skipped. The email is sent to the server system (block 104). The email is also analyzed to determine if the email satisfies selected criteria to warrant forwarding the email for delivery to the user's cell phone. The email is received and stored in an electronic data storage portion of the server system, such as on an email server (block 106). The email is stored at a unique location specific for that email. When multiple subscribers to the server system are receiving multiple emails on the server system's data storage portion, each of the emails must be safely stored in a separate and unique location so as to be accurately retrievable and deliverable to the correct user.

In the present invention, when an email is received and stored (block 106), the server system evaluates the email for specific information usable for prioritizing and/or delivering the email. In one embodiment, the email's header, body, footer and any attachments are evaluated, such that information in any one of these sections can be utilized in a desired selection process to determine how or what part of an email is to be delivered to the user and in what order.

If the email satisfies the pre-selected criteria, a message notification portion of the server system sends a notification to the cell phone or other wireless communication device indicating receipt of the email (block 108). The notification in the illustrated embodiment contains a selected WAP scheme and at least part of the WAP scheme provides a WAP session identifier that that server system assigns for the specific email from which the notification was sent. The WAP scheme can also include information about the email or parts of the email so as to provide information that is selected as important for the user relative to the email.

As indicated above, each email notification contains a session identifier specifically assigned or identified with the email message for that user. If the user has, as an example, three emails stored at the server system that meet the selected criteria, then three separate notifications will be sent to the user. Each notification will be embedded with a separate phone number or other data string usable by the cell phone for the specific email for which that notice was sent.

The notification is received by the cell phone (block 110) to let the user know that an email has been received.

When the notification with the embedded identification information is displayed on the cell phone screen, the user responds to the notification either in text format over a data channel portion (block 112) or in voice format over a voice channel portion (block 114) by activating the cell phone to connect with the server system. If the user elects to respond to the notification or otherwise access the server system over the data channel via a WAP session, the user establishes a text portion of the active communication session with the server system (block 116). If the user responds to the notification or otherwise accesses the server system by calling the server system via a voice channel, the cell phone activates a voice portion of the active communication session with the server system (block 118).

When the active communication session is established and the user initiates the text portion of a communication session as indicated above, the cell phone contacts the server system and the server system maps the cell phone's identification information, the WAP session identification, and the user account identification to the particular message for which the notification was sent (block 120). The server system then accesses the email (block 122) and downloads the email in text format (e.g., a WML page) to the cell phone (block 124). The server system also provides the menu of options for the user to interact with the server system for acting on the email. As an example, the menu items can include read, reply, reply to all, compose, delete, save, or other selected actions to be performed on the email by the server system.

When the communication session is in the text session portion, the communication exchange occurs in the WAP scheme to allow the user to act on the selected email as desired. The server system maintains the data session information regarding the status or actions on the email (block 126). Each activity on the email via the server system or the cell phone is continuously maintained so that if an active communication session is terminated and the user accesses the server system at a later date for that email, the user can initiate a new communication session where the previous session terminated. As a result, the server system maintains the data session information and allows for easy and fast interactive communications in both the text and voice formats between the cell phone and the server system to act on or manage the email or other electronic communications in their latest condition.

If the user has completed the desired actions with the email and via the server system, the user can terminate the active communication session (block 128). Alternatively, the active communication can be terminated if the activity between the server system and the cell phone is delayed or stops for a defined period of time. A new communication session can then be initiated by logging in to the server system or by responding to another email notification received from the server system.

If the user elects to continue the active communication session in text format, the user can continue the communication exchange in the WAP format over the data channel portion of the cell phone. If the user elects to switch to a voice format for acting on the email, the user can use the cell phone to select a menu item for a voice function, such as listening or replying to the email in voice format. The user activates the cell phone to select the desired menu option, thereby toggling the cell phone from the data session portion to the voice session portion (block 130). When the user toggles to the voice session portion, the text session portion of the active communication session is suspended (block 132). The cell phone then connects the server system on a voice channel (block 134) by calling the specific phone number for one of the server system's phone lines associated with the menu item selected by the user. Such connection establishes the voice portion of the active communication session with the server system (block 118).

When the voice portion of the active communication session is established, the server system identifies the phone number dialed by the cell phone, the cell phone ID, or other selected voice data strings, and the server system maps the voice data strings to the specific email message associated with the phone call from the cell phone (block 136). The server system accesses the specific email associated with the call from the cell phone (block 138), converts the email from text to speech, and delivers the email to the cell phone in the voice format over the voice channel (block 140). During the voice session portion of the active communication session, the user can conduct the voice-based communication exchange over the phone line to the server system for acting on the email (block 142). As an example, the user can listen to the email in voice format, and reply to the email in a voice format. The user can also compose an email in voice format. Replying or composing in voice format is achieved by the server system recording the oral message for the email, and the recording is attached to an email as a Wave File. The voice session can also be used to allow for voice commands for acting on the email, such as storing, deleting, saving, or other similar actions for the email.

The server system monitors and tracks the session data between the cell phone and the server system for the actions taken on the email during the voice portion of the communication session (block 144). If the user elects to perform several actions on the email over the voice channel, the voice session portion of the communication session continues over the voice channel. If the user completes the desired actions relative to the email and other emails, the user can terminate the communication session by ending the phone call from the cell phone to the server system (block 146).

If the user elects to continue the active communication session and desires to act further on the email in text format, the user toggles back to the text session portion by ending the phone call with the server system and sending a WAP session inquiry to the server system (block 146). The server system is configured to recognize when a phone call (voice session portion) from a user for an email is terminated and when a WAP session (text session portion) is resumed from the same user within a selected period of time. Accordingly, the active communication session continues between the server system and the user's cell phone for easy and seamless management of the user's email. In the event that the user does not respond to the server system in time, the server system will “time-out” and end the active communication session for security purposes.

When the user toggles from the voice session portion to the text session portion (block 148), the server system terminates the voice session portion (block 150) and reestablishes the text session portion and contacts the server system on the data channel (block 152). The text session portion is continued (block 116) so as to allow the user to continue interacting with the server system for management of the emails or other electronic communications in that user's account in the server system. Accordingly, the system of the illustrated embodiment allows the user to access the server system on either the voice or data channels portion of the cell phone and to toggle between communications on the data and voice channel portions during an active communication session. This provides the user with a wide-range of flexibility and options for easily and quickly managing the email or other electronic communications at the server system.

While the illustrated embodiment discussed above refers to a cell phone with a data channel and a voice channel, other embodiments can utilize wireless communication devices having a communication channel that can handle both voice and text communications over the same channel. The embodiments described above are discussed in connection with emails, although the above and other embodiments can be configured for handling other electronic communications in formats other than emails.

As an example, a user can access the server system in both voice and text formats and toggle therebetween to act on an electronic calendar data, address book data format, or other electronic data saved in the server system for the specific user's account. The user can then navigate through the electronic data in either voice or text formats with seamless toggling between voice and text communications with the server for addressing and managing the electronic data.

The above description of illustrated embodiments of the invention is not intended to be exhaustive or to limit the invention to the precise form disclosed. While specific embodiments of, and examples for, the invention are described herein for illustrative purposes, various equivalent modifications are possible within the scope of the invention, as those skilled in the relevant art will recognize. The teachings of the invention provided herein can be applied to other email server or delivery systems and wireless communication devices, not necessarily limited to the server system and cell phones described above.

The elements and steps of the various embodiments described above can be combined to provide further embodiments. As an example, the electronic communications provided to the wireless communication device over a selected channel in a suitable protocol may include text, graphics, or voice-based communications. The server system could be configured to allow the user to toggle between delivery of text, graphics, and voice-based communications to the wireless device for data management.

These and other changes can be made to the invention in light of the above detailed description. In general, in the following claims the terms used should not be construed to limit the invention to the specific embodiments disclosed in the specification and the claims. The claims should be construed to include all systems and methods that operate under the claims to provide email to a wireless communication device. Accordingly, the invention is not limited by the disclosure, but instead the scope of the invention is to be determined entirely by the claims.

1. A mobile communication management system for management of electronic communications to and from a wireless communication device in text and speech formats, the wireless communication device being associated with a user and having a unique identifier, comprising:
an electronic data storage portion configured to receive and store electronic communication for a specified user in a unique storage location;
a message notification portion configured to provide notification to the wireless communication device of receipt of the electronic communication by the data storage portion; and
a message delivery portion configured to receive message delivery instructions from the wireless communication device and to transmit the electronic communication to the wireless communication device, the message delivery portion being configured to receive the message delivery instructions through a data channel and a voice channel of the wireless communication device during an active communication session between the wireless communication device and the message delivery portion, and the message delivery portion being configured to allow the user to toggle between the data and voice channels of the wireless communication device for transmission of the electronic communication between the wireless communication device and the message delivery portion as selected by the user during a single active communication session.

2. The mobile communication management system of claim 1 wherein the message delivery portion is configured to terminate the active communication session if a response communication from the wireless communication device has not been received over the data or voice channel within a selected period of time.

3. The mobile communication management system of claim 1 wherein the message delivery portion is configured to receive a first message delivery instruction from the wireless communication device over the voice channel and a second message delivery instruction from the wireless communication device over data channel during the active communication session.

4. The mobile communication management system of claim 1 wherein the message delivery portion is configured to deliver a response communication in WAP format to the wireless communication device over the data channel and in speech format over the voice channel.

5. The mobile communication management system of claim 1 wherein the message delivery portion provides the wireless communication device with a menu of options for the acting on the electronic communication in speech format over the voice channel and in text format over the data channel.

6. The mobile communication management system of claim 5 wherein the message delivery portion is configured to record an oral response from the wireless communication device over the voice channel and saving the recorded response in a Wave File.

7. The mobile communication management system of claim 1 wherein the message delivery portion is configured to receive a first response from the wireless communication device over the data channel, to provide menu data to the wireless communication device over the data channel in response to the first response, and to receive a second response from the wireless communication device over the voice channel in response to the menu data during the active communication session.

8. The mobile communication management system of claim 9 wherein the message delivery portion is configured to receive a third response from the wireless communication device over the data channel after receiving the second response during the communication after the user activates the wireless communication device to toggle from the voice channel to the data channel.

9. The mobile communication management system of claim 1 wherein the message delivery portion is configured to maintain the active communication session with the wireless communication device, the communication session including a data communication portion in a Wireless Application Protocol (WAP) over the data channel and a voice communication portion over the voice channel.

10. The mobile communication management system of claim 9 wherein the message notification portion is configured to deliver a notification to the wireless communication device regarding the electronic communication, the notification includes a menu of options for acting on the electronic communication in data and speech formats.

11. The mobile communication management system of claim 1 wherein the message delivery portion is configured to receive a first communication from the wireless communication device in speech format over the voice channel and configured to receive a second communication from the wireless communication device in text format over the data channel after the first response during the communication session.

12. The mobile communication management system of claim 1 wherein the message delivery portion is configured to send and receive communication from the wireless communication device over the data channel during a data portion of the active communication session until an response communication is received from the wireless communication device over the voice channel, the message delivery portion is configured to suspend the data portion of the communication session and transition to a voice portion of the active communication session.

13. The mobile communication management system of claim 12 wherein the message delivery portion is configured so the data portion of the active communication session is resumed after the voice portion of the active communication session ends.

14. The mobile communication management system of claim 1 wherein the message delivery portion is configured to receive communications from the wireless communication device over both the data and voice channels as selected by the user during the active communication session, and to deliver communications to the wireless communication device over both the data and voice channels as selected by the user during the active communication session.

15. The mobile communication management system of claim 1 wherein the message delivery portion is configured to map the message delivery instructions to the electronic communication at the electronic storage portion and to deliver a response communication over the data channel or voice channel from which the message delivery instructions were received during the active communication session.

16. An information communication delivery system for managing electronic communications received from a remote computer server, comprising:
a wireless communication device having a unique device identifier and having a data channel portion and a voice channel portion for receiving and delivering the electronic communications; and
a server system configured to receive the electronic communications for a specified user from the remote server and to store the electronic communication data in a unique location for the wireless communication device, the server system configured to receive from the wireless communication device a device communication associated with a selected electronic communication, the server system also configured to identify the device identifier, and to map the device communication and the device identifier to the selected electronic communication, the server system receives message delivery instructions over a data channel portion and a voice channel portion of the wireless communication device during an active communication session between the wireless communication device and the server system, the server system allows the user to toggle between the data and voice channel portions a plurality of times for transmission of the communication data in text format and speech format between the wireless communication device and the server system during the active communication session, and the server system receives electronic instructions from the wireless communication device over the data and voice channel portions to act on the selected electronic communication as selected by the user during the active communication session.

17. The information communication delivery system of claim 16 wherein the server system is configured terminate the active communication session if a response communication from the wireless communication device has not been received over the data or voice channel portions within a selected period of time.

18. The information communication delivery system of claim 16 wherein the server system is configured to receive a first message delivery instruction from the wireless communication device over the voice channel portion and a second message delivery instruction from the wireless communication device over data channel portion after the user activates the wireless communication device to toggles from the voice channel portion to the data channel portion.

19. The information communication delivery system of claim 16 wherein the server system is configured to transmit the communication data in text format over the data channel portion and in speech format over the voice channel portion.

20. The information communication delivery system of claim 16 wherein the server system provides over the data channel portion the wireless communication device with a menu of options in text format for the acting on the electronic communication, including delivery of the electronic communication in speech format over the voice channel portion and in text format over the data channel portion.

21. The information communication delivery system of claim 16 wherein the server system is configured to record a response from the wireless communication device over the voice channel portion and saving the recorded response in a Wave File, and then receiving communication data from the wireless communication devise in text format over the data channel portion during the active communication session.

22. The information communication delivery system of claim 16 wherein the server system is configured to provide the communication data to the wireless communication device on the voice and data channel portions in response as selected to the user by toggling the wireless communication device during the active communication session.

22. The information communication delivery system of claim 16 wherein the server system is configured to receive a first response from the wireless communication device over the data channel portion, to provide menu data to the wireless communication device over the data channel portion in response to the first response, and to receive a second response from the wireless communication device over the voice channel portion in response to the menu data during the active communication session.

23. The information communication delivery system of claim 22 wherein the server system is configured to receive a third response from the wireless communication device over the data channel portion after receiving the second response during the active communication session.

24. The information communication delivery system of claim 16 wherein the server system is configured to conduct the active communication session that includes a data communication portion in a Wireless Application Protocol (WAP) format over the data channel portion and a voice communication portion in a voice-based format over the voice channel portion.

25. The information communication delivery system of claim 16 wherein the server system is configured to receive a first response from the wireless communication device in speech format over the voice channel portion and configured to receive a second response in text format over the data channel portion during the active communication session after the first response.

26. The information communication delivery system of claim 16 wherein the server system is configured to send and receive communication from the wireless communication device over the data channel portion during a text session portion of the active communication session until a response communication is receive d from the wireless communication device over the voice channel portion, the server system suspending the data portion of the active communication session and transitioning to a voice session portion of the active communication session when the text session portion is suspended.

27. The information communication delivery system of claim 26 wherein the server system is configured to resume the text session portion of the communication session is resumed after the voice portion has ended.

28. The information communication delivery system of claim 27 wherein the server system is configured so the next session portion is resumed upon receiving an electronic communication over the data channel portion of the wireless communication device within a selected period of time from the end of the voice session portion.

29. The information communication delivery system of claim 16 wherein the server system is configured to maintain data session information about the actions taken by the server system in connection with the electronic communication during the active communication session with the wireless communication device.

30. The information communication delivery system of claim 16 wherein the wireless communication device is a cellular telephone having a electronic communications browser programmed therein for handling electronic data received over the data channel portion.

31. The information communication delivery system of claim 16 wherein the wireless communication device is a WAP-enabled cellular phone configured to interact with the server system during a WAP session over the data channel.

32. A wireless communication system for toggling with a wireless communication device between and voice data transmission in text and voice format, comprising:
an electronic data storage portion configured to receive and store electronic communication data;
a message handling portion configured to communicate with the wireless communication device in text format over a data channel portion and in voice format over voice channel portion during an active communication session with the wireless communication device and to deliver the electronic communication data to the wireless communication device, the message delivery portion configured to allow the user to toggle between the data and voice channel portions whereby the electronic communication data is transmitted between the message handling portion and the wireless communication device in a first transmission over the data channel portion in text format in a second transmission over the voice channel portion in voice format after the first transmission, and in a third transmission over the data channel in text format after the second transmission, the first, second, and third transmissions occurring in the active communication session.

33. A method of delivering data to and from a wireless communication device to toggle between text and voice delivery formats, the wireless communication device having a data channel portion and a voice channel portion, comprising:
receiving an electronic communication by a server system, the electronic communication being addressed to a specific user;
storing the electronic communication in the server system;
providing data from the server system to the wireless communication device associated with the user about the stored electronic communication;
establishing an active communication session between the server system and the wireless communication device for acting on the stored electronic communication; and
allowing the user to toggle between the text and voice channel portions with the wireless communication device to provide instruction communications to the server system for acting on the electronic communication in text-based formats and in voice-based formats during the active communication session.

34. The method of claim 33, further comprising providing the electronic communication to the wireless communication device over the data or voice channel portions indicating the presence of the electronic communication at the server system.

35. The method of claim 33, further comprising maintaining data session information about the actions taken for the electronic communication.

36. The method of claim 33 further comprising receiving data in text format by the wireless communication devise over the data channel portion, toggling from the data channel portion to the voice channel portion while in the active communication session and receiving data in voice format, and then toggling back to the data channel portion while in the active communication session and receiving data in text format over the data channel portion.

37. A method of receiving and responding to an electronic communication with text or speech from a wireless communication device, the wireless communication device being associated with a user and having a voice channel portion and a data channel portion, comprising:
receiving a notification that the electronic communication for the user has been received by a server system, the notification being received by the wireless communication device on the data channel portion of the wireless communication device;
sending a response communication from the wireless communication device to the server system over the voice or data channel portion in response to the notification to establish a communication session between the wireless communication device and the server system;
toggling the wireless communication device between the data and voice channel portions upon activation of the wireless communication device for communication with the server system during the same communication session.

38. A method of toggling between data and voice data delivery to or from a wireless communication device, the wireless communication device having a data channel portion and a voice channel portion for sending or receiving information, comprising:
receiving an electronic communication by a server system from a remote server, the electronic communication being addressed to a specific user;
storing the electronic communication in the server system in a unique storage location for that electronic communication;
providing data from the server system to a wireless communication device associated with the user indicating the electronic communication device stored for the user;
receiving a communication from the wireless communication device, the wireless communication device having an identification information associated therewith;
mapping the identification information of the wireless communication device with the electronic communication for the user for delivery to the wireless communication device;
providing an electronic communication to the wireless communication device over the data channel portion indicating the presence of the electronic communication at the server system;
establishing a communication session between the server system and the wireless communication device over the data channel portion for acting on the electronic communication in the server system;
providing to the wireless communication device over the data channel a menu of options for acting on the electronic communication during a data portion of the communication session;
receiving a first instruction communication from the wireless communication device over the voice channel portion regarding the electronic communication,
suspending the data portion of the communication session when the first instruction communication is received over the voice channel and initiating a voice portion of the communication session;
providing a response to the first instruction communication received over voice channel portion;
receiving a second instruction communication from the wireless communication device of the data channel portion after providing the response to the instruction communication received over the voice channel portion;
reinstating the data portion of the communication session when the second instruction communication is received over the data channel portion;
acting on the second instruction communication regarding the electronic communication; and
terminating the communication session with the wireless communication device upon receiving instructions to terminate or is instruction communications for the electronic communication are not received within a selected time period.
